(19) United States
(12) Patent Application Publication
(10) Pub. No.: US 2002/0179389 A1
(43) Pub. Date: Dec. 5, 2002

(54) Hydraulic piston assembly

(76) Inventor: Seiji Sawai, Shizuoka (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/132,747

(22) Filed: Apr. 25, 2002

(30) Foreign Application Priority Data
Apr. 25, 2001 (JP) 2001-128488

(51) Int. Cl. F16F 9/36

(52) U.S. Cl. 188/322.18

(57) ABSTRACT

A hydraulic piston assembly includes a cylinder assembly having an inner bore that defines an internal space. A piston is disposed in the space and divides the space into first and second fluid chambers. The piston comprises a side annular surface, a first surface adjacent the first fluid chamber and a second surface adjacent the second fluid chamber. The side annular surface comprising a first portion, a second portion and an annular groove between the first and second portions. The first portion has a maximum diameter that is less than the maximum diameter of the second portion. A sealing member is positioned within the annular groove. In some embodiments, the cylinder assembly forms part of a dampening system that interrelates at least two suspension assemblies. Methods for assembling the hydraulic piston assembly are also disclosed.

### RELATED APPLICATIONS

This application is based upon and claims the priority of Japanese Patent Application No. 2001-128488, filed on Apr. 25, 2001, which is hereby incorporated by reference in its entirety.

### BACKGROUND OF THE INVENTION

1. Field of the Invention

The invention relates to a vehicle suspension system and more particularly to a sealing arrangement for a hydraulic piston of the vehicle suspension system.

2. Description of the Related Art

Conventional vehicle suspension systems include at least one hydraulic shock absorber. Each shock absorber typically includes a piston that reciprocates within a hollow cylinder. The piston is fixed to one end of a piston rod and the piston is disposed within the internal space of the cylinder to divide the cylinder into first and second chambers. The chambers are typically filled with a fluid such as oil to resist the motion of the piston within the cylinder. The reciprocating movement of the piston is resisted because the fluid must flow through a resistance mechanism when flowing from one chamber to the other chamber. Typically, the resistance mechanism comprises throttle plates or check valves that control the damping of the shock absorber. The movement of the fluid through the resistance mechanism dissipates the input energy to the shock absorber by displacing the fluid through the resistance mechanism. The velocity of the reciprocating piston, which determines the amount of energy dissipated, is controlled by the amount of resistance to the fluid flow.

U.S. Pat. No. 6,250,658 describes a vehicle suspension system wherein each wheel is associated with an individual shock absorber to provide individual wheel dampening. As best seen in FIG. 2 of the '658 patent, the shock absorbers for at least two wheels are coupled together by a dampening system, which includes a hydraulic cylinder to control the roll and pitch of the vehicle. More specifically, the hydraulic cylinder includes a cylinder body, which defines a cylinder bore and is supported on the body of the vehicle. A piston is positioned within the cylinder bore and divides the cylinder bore into a first and second chamber. The piston includes an annular groove and an elastic sealing ring that is positioned in the annular groove. The sealing ring presses against the bottom surface of the annular groove and the cylinder bore to form a tight seal between the piston and the bore and between the first and second chambers. Hydraulic pipes are provided for coupling the hydraulic cylinder to the internal spaces of the associated shock absorbers.

As each of the shock absorber moves up and down with the upward and downward movement of the wheels, the piston of the hydraulic cylinder slides back and forth to dampen the upward and downward movement of both shock absorbers as fluid in the first and second chambers pass through a valve in the piton. In this manner, the dampening system reduces rolling and pitching of the vehicle.

### SUMMARY OF THE INVENTION

Assembling the hydraulic cylinder involves fitting the sealing ring into the annular groove. Typically, this involves radially expanding the sealing ring such that it deforms elastically and fits over one end of the piston. The sealing ring is then slid along the piston until the ring reaches the annual groove and contracts to its original shape within the groove.

There are several problems associated with the above-described method for assembling the hydraulic cylinder. For example, the sealing ring may undergo plastic deformation as it is expanded to fit over the end of the piston body. This may prevent the sealing ring from returning to its original shape, which will reduce the contact force between the sealing ring and the piston and reduce the effectiveness of the seal. Another problem associated with the above-described method is that, after the seal ring is positioned in the annular groove, its outside diameter is significantly larger than the outside diameter of the piston. This makes inserting the piston into the cylinder bore difficult as the outside edge of the sealing ring can become caught on the opening edge of the bore.

Accordingly, in one aspect of the present invention is a hydraulic suspension system comprising a cylinder assembly having an inner bore that defines an internal space. A first piston is disposed within the internal space to separate the internal space into a first fluid chamber and a second fluid chamber. The piston comprising a side annular surface located adjacent the internal bore, a first surface adjacent the first fluid chamber, and a second surface located adjacent the second fluid chamber. The side annular surface comprises a first annular surface located adjacent the first surface, a second annular surface located adjacent the second surface, and an annular groove that lies between the first annular surface and the second annular surface. The first annular surface has a maximum diameter that is less than the maximum diameter of the second annular surface. A first sealing member is positioned within the groove.

Another aspect of the present invention is a hydraulic suspension system that comprises a cylinder assembly having a smaller diameter portion with a first inner bore that defines small diameter internal space and larger diameter portion with a second inner bore that defines a large diameter internal space that is in communication with the small diameter internal space. A piston rod extends within the small and larger diameter internal spaces. A first piston is coupled to the piston rod and is disposed within the large diameter space to separate the large diameter space into a first fluid chamber and a second fluid chamber. A second piston is coupled to the piston rod and is disposed with the small diameter internal space to separate the small diameter space into a third fluid chamber and a fourth fluid chamber. The third fluid chamber being in communication with the first fluid chamber. The first piston comprising a side annular surface located adjacent the internal bore, a first surface adjacent the first fluid chamber, and a second surface located adjacent the second fluid chamber. The side annular surface comprises a first annular surface located adjacent the first surface, a second annular surface located adjacent the second surface, and an annular groove that lies between the first annular surface and the second annular surface. The first annular surface having a maximum diameter that is less than the maximum diameter of the second annular surface. A first sealing member is positioned within the annular groove.

Yet another embodiment of the present invention is a method for assembling a hydraulic cylinder of a hydraulic suspension system. The method comprises providing a piston with a side annular surface, a first surface, and a second surface. The side annular surface includes a first annular surface located adjacent the first surface, a second annular surface located adjacent the second surface, and an annular groove that lies between the first annular surface and the second annular surface. The first annular surface has a maximum diameter that is less than the maximum diameter of the second annular surface. The method further comprises providing a cone shaped jig having a first end with a smaller diameter than a second end of the jig, providing an annular press, placing the second end of the jig adjacent the first surface of the piston, placing a sealing ring adjacent the first end of the jig, and using the annular press to move a sealing ring over the jig and onto the annular surface of the piston and into the annular groove.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

FIG. 1 is a partially schematic cross-sectional view of a suspension system that comprises a hydraulic cylinder having certain features and advantages according a preferred embodiment of the present invention.

FIG. 2 is an enlarged cross-sectional view of a portion of FIG. 1.

FIG. 3 is an enlarged cross-sectional view of a portion of FIG. 2 showing a modified embodiment.

FIG. 4 is an enlarged cross-sectional view of a portion of the hydraulic cylinder showing how a sealing ring is inserted onto a piston of the hydraulic cylinder.

### DETAILED DESCRIPTION OF THE PREFERRED EMBODIMENT

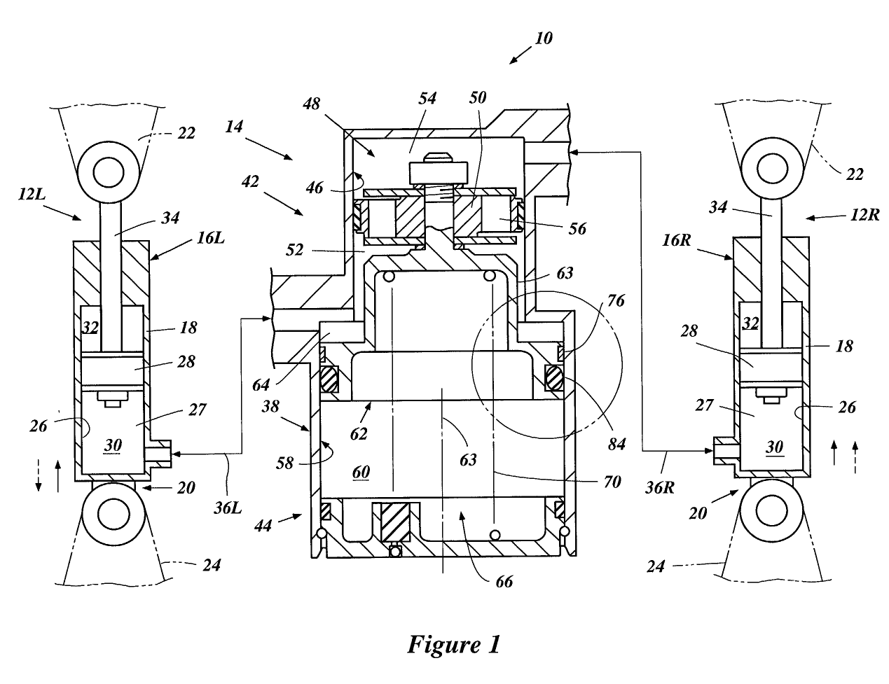

FIG. 1 illustrates a suspension system 10 that includes a left suspension assembly 12L, a right suspension assembly 12R, and a dampening system 14 having certain features and advantages according a preferred embodiment of the present invention. As will be explained below, the illustrated dampening system 14 interrelates the left and right suspension assemblies 12L, 12R (i.e., suspension assemblies associated with the wheels located on the left and right sides of a vehicle). Such an arrangement is particularly useful in dampening and controlling vehicle roll, which can occur when the vehicle is cornering. However, it should be appreciated that the dampening system 14 can also be used to interrelate front and rear suspension assemblies (i.e., suspension assemblies associated with the wheels located on the front and rear sides of a vehicle). Such an arrangement is particularly useful in dampening and controlling vehicle pitch, which can occur during acceleration or deceleration. The dampening system 14 may also be used interrelate more than two suspension assemblies from the left, right, front or rear sides of the vehicle.

The left and right suspension assemblies 12L, 12R include a hydraulic damper 16L, 16R. Each hydraulic damper 16L, 16R comprises a cylinder assembly 18 that has a trunnion portion 20 for attachment to either the vehicle body 22 or a wheel suspension 24 for the wheel (not shown). In the illustrated embodiment, the trunnion portion 20 is attached to the wheel suspension 24.

The cylinder assembly 18 defines a cylinder bore 26, which defines an internal chamber 27. A piston 28 is positioned in the internal chamber 27 and divides the internal chamber 27 into a lower or working chamber 30 and an upper or reservoir chamber 32. These chambers 30, 32 are sealed from each other by sealing members carried by the piston 28. A control valve or control passage (not shown) is preferably provided in the piston 48 for permitting a controlled amount of flow between the working chamber 30 and the reservoir chamber 32. In a modified embodiment, the control valve or passage can be provided in a bypass passage.

A piston rod 34 extends through the reservoir chamber 32 and is connected to the vehicle body 22. As noted above, the arrangement of the suspension assembly 12L, 12R can be reversed. That is, the piston rod 34 can be connected to the wheel suspension 24 while the tunnion portion is connected to the vehicle body 22.

The working chambers 30 of the left and right suspension assemblies 12L, 12R are connected to the dampening system 14 by a pair of pressure lines 36L, 36R such that the left and right suspension assemblies 12L, 12R are in hydraulic communication with the dampening system 14. It should be appreciated that the functions and positions of the working chamber 30 and the reservoir chamber 32 can be reversed.

With continued reference to FIG. 1, the dampening system 14 will now be described. The dampening system 14 comprises a cylinder assembly 38, which, in the illustrated embodiment, comprises a first smaller diameter portion 42 and a second larger diameter portion 44. The smaller diameter portion 42 has an internal bore 46 that defines a smaller diameter chamber 48 in which a first piston 50 is positioned. The first piston 50 divides the smaller diameter chamber 48 in to a first sub-chamber 52 and a second sub-chamber 54. In the illustrated embodiment, the working chamber 30 of the left suspension assembly 12L is connected to the first sub-chamber 52 by the pressure line 36L. In a similar manner, the working chamber 30 of the right suspension assembly 12R is connected to the second sub-chamber 54 by the pressure line 36R. A small passage or pressure valve 56 is provided in the first piston 50. The passage 56 permits controlled flow of fluid between the first and second sub-chambers 52, 54 to provide dampening as will be explained in more detail below. It should be appreciated that in modified embodiments the valve 56 can be placed outside or within the cylinder assembly 38 in a bypass passage.

The larger diameter portion 44 also has an internal bore 58, which defines a larger diameter chamber 60 in which a second piston 62 is positioned. The first and second pistons 50, 62 are coupled together by a piston rod 63 such that they move in unison along a longitudinal axis 63 of the cylinder assembly 38. The second piston 62 divides the larger diameter chamber 60 into a third and fourth sub-chambers 64, 66. In the illustrated arrangement, the first and third sub-chambers 52, 64 of the smaller and larger diameter chambers 48, 60 lie adjacent to each other (i.e., the first and third sub-chambers 52, 64 are in communication with each other). In the illustrated embodiment, a spring 70 is provided in the fourth sub-chamber 66 for biasing the pistons 50, 62 toward the second sub-chamber 54.

Preferably, the internal chambers 27 of the suspension assemblies 12L, 12R and the smaller diameter chamber 48 of the dampening system 12 are filled with a fluid or oil. In contrast, the fourth sub chamber 66 is preferably filled with a fluid or gas (e.g., nitrogen).

The operation of the suspension system 10 will now be described with continued reference to FIG. 1. When both the left and right wheels encounter the same obstacle, the wheels may be raised as indicated by the solid arrows in FIG. 1. Such movement will compress the fluid in the working chambers 30 of the left and right suspension assemblies 12L, 12R. The compressed fluid is forced through the control valves in the piston 28 into the reservoir chambers 32. Some of the compressed fluid may also be forced through the pressure lines 36L, 36R into the dampening system 14. Because the left and right suspension assemblies 12L, 12R are displaced the same amount, an equal amount of fluid is displaced in each suspension assembly 12L, 12R and no fluid will be displaced between the assemblies 12L, 12R. More specifically, the pressure in the first and second sub-chambers 52, 54 are equal and no fluid passes through the valve 56. Because the cross-sectional area of the second piston 62 is greater than the first piston 50, the two pistons 62, 50 move downwardly and their motion is dampened by the gas in the fourth sub-chamber 66 and/or the spring 70. In this situation, the suspension assemblies 12L, 12R essentially operate as conventional shock absorbers.

In a similar manner, when both the left and right wheels encounter the same obstacle, the wheels may be depressed in a direction opposite the direction indicated by the solid arrows in FIG. 1. In such a situation, the fluid in the reservoir chambers 32 is compressed and forced through the control valves in the piston 28 into the working chamber 30. Some fluid from the dampening system 14 may also flow into the working chamber 30. Because the left and right suspension assemblies 12L, 12R are displaced the same amount, an equal amount of fluid is displaced in each suspension assembly 12L, 12R and no fluid will be displaced between the assemblies 12L, 12R. The two pistons 50, 62 move upwardly and their motion is dampened by the gas in the fourth sub-chamber 66 and/or the spring 70.

When, for example, the vehicle is cornering, the left and right suspension assemblies will be moved in opposite directions as indicated by the dashed arrows of FIG. 1. This causes the fluid in the working chamber 30 of the right assembly 12R to be rapidly compressed while the working chamber 30 of the left assembly 12L is rapidly expanded. Thus, fluid is withdrawn from the first sub-chamber 52 of the dampening system 14 and fluid is delivered to the second sub-chamber 54. This creates a pressure differential between the first and second sub-chambers 52, 54. The valve 56 permits controlled flow between the first and second sub-chambers 52, 54 to reduce and control the body roll caused by the cornering.

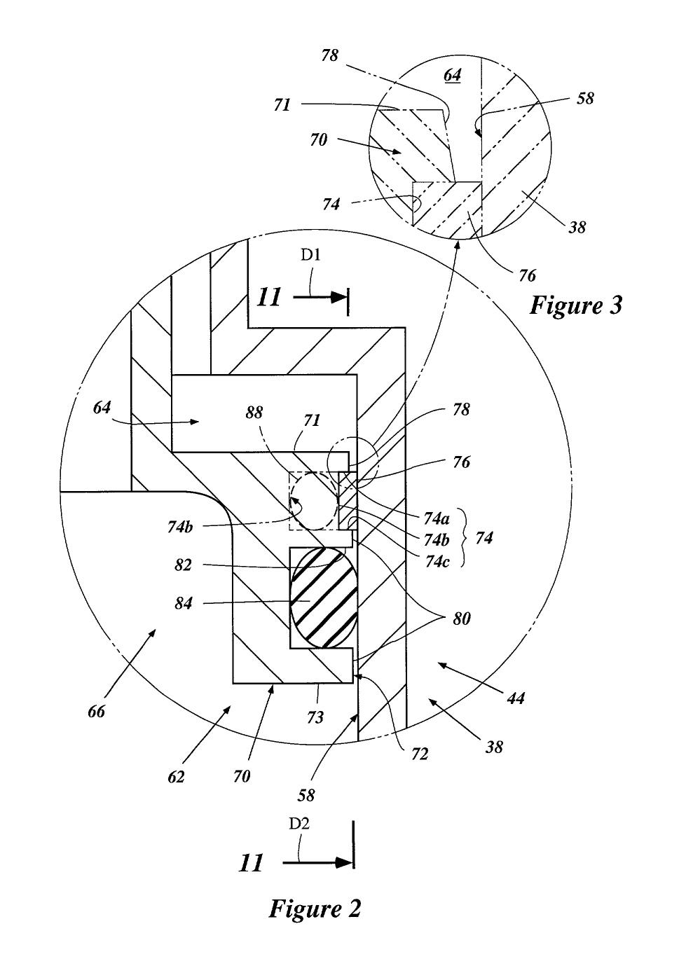

The physical structure of the dampening system will now be described in more detail with initial reference to FIG. 2. The second piston 62 includes a piston body 70. The piston body 70 has top end surface 71, a side annular surface 72, and a bottom end surface 73. The side annular surface 72 includes an annular groove 74 that includes an top surface 74a, a side surface 74b and a bottom surface 75c. A first sealing ring 76 is fitted into the annular groove 74 such that it engages the upper, side and lower surfaces 74a-c. In one embodiment, the first sealing ring 76 is preferably made of an elastic material, such as, for example, polytetrafluoroethylene (e.g., Teflon™).

With continued reference to FIG. 2, the outer annular surface 72 comprise a first or upper portion 78, which is generally located above the annular groove 74 in an axial direction, and a second or lower portion 80, which is generally located below the annular groove 74. The second portion 80 preferably also includes another annular groove 82. A second sealing ring 84 is positioned within the annular groove 82. In one embodiment, the elastic sealing ring is made of an elastic material, such as, for example, rubber.

Both the first and second sealing rings 76, 84 are configured such that their outer circumferential surfaces contact and press against the inside circumferential surface of the large diameter chamber 60. The first and second sealing rings 76, 84 therefore seal the third sub-chamber 64 from the fourth sub-chamber 66. Preferably, the first sealing ring 76 is made from a material that is harder (i.e., has a higher modulus of elasticity) than the material of the second sealing ring 84. In one embodiment, the first sealing ring 76 is made of polytetrafluoroethylene (e.g., Teflon™) and the second sealing ring 84 is made of rubber.

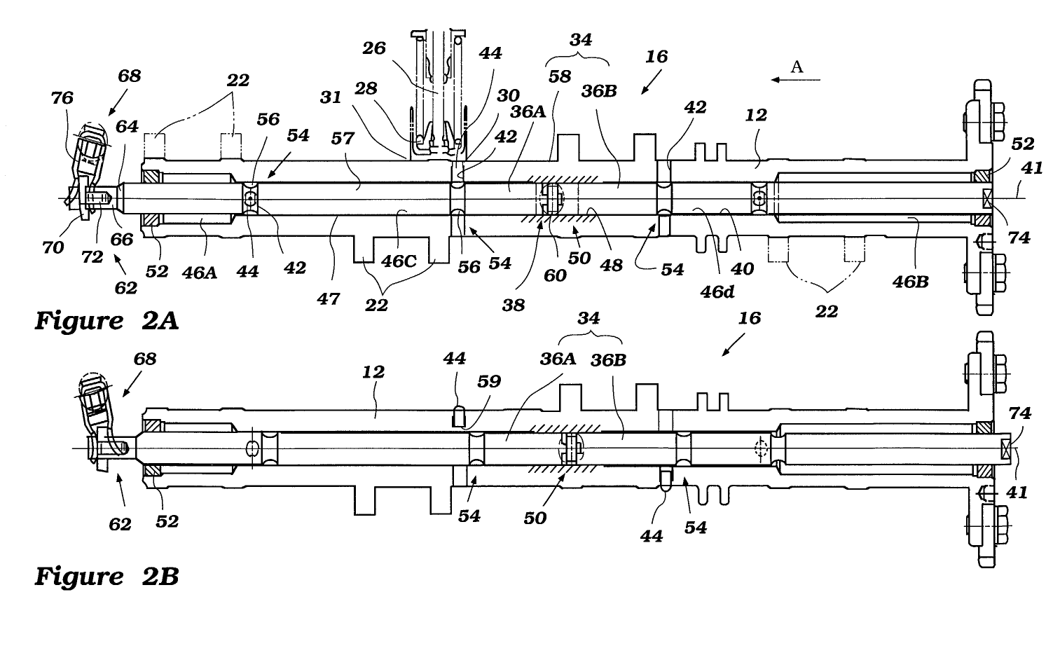

To aid assembling, the first or upper portion 78 of the illustrated embodiment has a maximum outer diameter D1 that is smaller than the maximum diameter D2 of the lower portion 80. In a modified embodiment, which is illustrated in FIG. 3, the diameter D1 of the upper portion.78 gradually decreases from the annular groove 74 to the top end 71 of the second piston 62. Preferably, in both embodiments, the upper or smaller diameter portion 78 of the annular surface 72 is located adjacent the third sub-chamber chamber 64, which generally is configured to have a larger maximum hydraulic pressure as compared to the fourth sub-chamber 66 as will be explained below. In a similar manner, the lower portion 80 is preferably located adjacent the fourth sub-chamber 66.

In a modified embodiment, which is indicated by the dashed lines in FIG. 2, a third sealing ring 88 is placed between the side surface 74b of the annular groove 74 and the first sealing ring 76. The third sealing ring 88 urges the first sealing ring 76 radially outward. The third sealing ring 88 is preferably made of a material that is more elastic (i.e., has a lower modulus of elasticity) than the material of the first sealing ring 76. For example, in one embodiment, the first sealing ring 76 is made of polytetrafluoroethylene (e.g., Teflon™) while the third sealing ring 88 is made of rubber. This arrangement is advantageous because the third sealing ring 88, which has a smaller diameter than the first sealing ring 76, must undergo more deformation than the first sealing ring 76 as it is inserted over the first end 71 of the second piston 62. As such, forming the third sealing ring 88 out a more elastic material allows it to be more easily inserted over the first end 71 of the second piston 62. This arrangement also allows the first sealing ring 76 to have a larger relaxed diameter because it is fitted over the third sealing ring 88. Thus, the first sealing ring 76 can be made of a more resilient material because it undergoes less deformation when it is fitted over the first end 71 of the second piston 62.

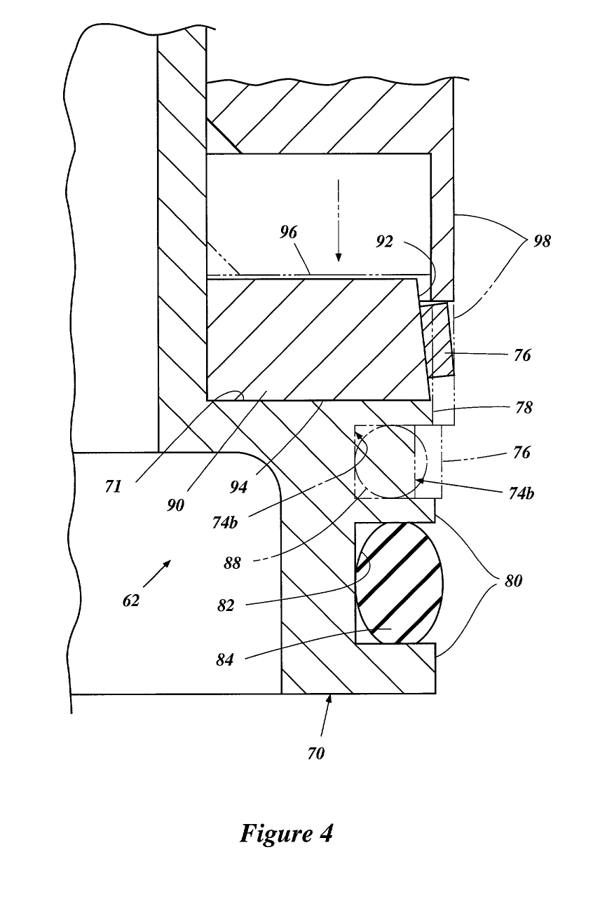

A method for positioning the sealing ring 76 on the second piston 62 will now be described with reference to FIG. 4. A cone shaped jig 90 is placed over the first end 71 of the second piston 62. The cone shaped jig 90 has an outer surface 92 that has a larger diameter on the side 94 that faces the first end 71 of the second piston 62. The first sealing ring 76 is fitted over a smaller diameter side 96 of the jig 90. An annular press 98 is used to move the first sealing ring 76 from the smaller diameter side 96 of the jig 90 towards the larger diameter side 94 of the jig 90. In this manner, the first sealing ring 76 is gradually expanded until it reaches the first portion 78 of the second piston 62. The annular press 98 continues to move the first sealing ring 76 along the first portion 78 of the second piston 62 until the first sealing ring 76 falls into the annular groove 74 as indicated by the phantom lines in FIG. 4.

The embodiments described above have several advantages. For example, as described above, the maximum outside diameter D1 of the first portion 78 is smaller than the maximum diameter D2 of the second portion 80. Therefore, less work is required to pass the first sealing ring 76 over the second piston 62 and into the annular groove 74. This also reduces the amount that the first sealing ring 76 has to expand; so the sealing ring 76 is less likely to become damaged or deformed. This preserves the elasticity of the first sealing ring 76 and promotes a tighter seal between the second piston 62 and the larger diameter chamber 60.

Another advantage of the illustrated embodiments is that, because the first sealing ring 76 can be made of a more resilient material, its outside diameter can be configured to more closely match the inside diameter of the larger diameter chamber 60. If the first sealing ring 76 is made of a less resilient material (e.g., rubber), the sealing ring 76 would generally have an outside diameter that is significantly larger than the inside diameter of the larger diameter chamber 60 to ensure a tight seal. By forming the first sealing ring 76 out of a more resilient material, the diameter of the first sealing ring 76 can be only slightly larger than the inside diameter of the larger diameter chamber 60 while still maintaining a tight seal. This arrangement prevents the first sealing ring 76 from being caught on the opening edge of the cylinder assembly 38 when the second piston 62 is inserted into the larger diameter chamber 60.

Another advantage of the illustrated embodiments is that the length of the first portion 78 of the second piston 62 is less than the length of the second portion 80 of the second piston 62. As such, the first sealing ring 76 travels a smaller distance along the second piston 62.

In the embodiment illustrated in FIG. 3, the outside diameter of the first portion 78 tapers outwardly toward the annular groove 74. In this arrangement, the first sealing ring 76 is gradually expanded before it is fitted over the first portion 78. This reduces the amount of work required to fit the sealing ring 76 onto the piston 62.

Another advantage of the illustrated embodiment is that the smaller diameter first portion 78 is located adjacent the first and third sub-chambers 52, 64. As explained above, in the illustrated embodiment, the second piston 62 is biased by a spring 70. As such, the dampening system 14 is configured such the maximum hydraulic pressure in the first and third sub-chambers 52, 64 is higher than maximum hydraulic pressure in the fourth sub-chamber 66. As such, the hydraulic pressure of the first and third sub-chambers 52, 64 presses the first sealing ring 76 against the bottom surface 74c of the annular seal 74. Because the diameter of the bottom portion 80 is larger than the diameter of the upper portion 78, the lower surface 74c of the annular groove 74 has a greater surface area than the upper surface 74a of the annular groove 74. Thus, the larger hydraulic force of the first and third sub-chambers 52, 64 is spread out over the larger cross-sectional area of the lower surface 74c. This reduces the stress on the first sealing ring 76 and increases the its service life.

In the embodiment illustrated in dashed lines in FIGS. 2 and 4, the second piston 62 includes a third sealing member 88 that is placed between the side surface 74b of the annular groove 74 and the first sealing member 76. The third sealing ring 88 urges the first sealing ring 76 outwardly. As mentioned above, the third sealing ring 88 is preferably made of a material that has a lower modulus of elasticity than the material of the first sealing ring 76. This arrangement, permits the more elastic sealing ring (i.e., the third sealing ring 88) to have a smaller diameter and still be fitted easily into the annular groove 74. This also allows the first sealing ring 76 to have a larger inside diameter such that it is deformed less when inserted over the first end 71 of the second piston 62 without causing plastic deformation of the first sealing ring 76.

The illustrated embodiments show certain features and aspects of the present invention as applied to the damping system 14 of the suspension system 10. However, it should be appreciated that certain features and advantages of the illustrated embodiments may also find utility in other parts of the suspension system 10. For example, certain aspects of the arrangement of the second piston ring 62 and the first sealing ring 76 may also be applied to the piston 28 of the left and right suspension assemblies 12L, 12R.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. For example, it is contemplated that various combination or sub-combinations of the specific features and aspects of the embodiments may be made and still fall within the scope of the invention. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above, but should be determined only by a fair reading of the claims that follow.

What is claimed is:

1. A hydraulic suspension system comprising a cylinder assembly having an inner bore that defines an internal space, a first piston being disposed within the internal space to separate the internal space into a first fluid chamber and a second fluid chamber, the piston comprising a side annular surface located adjacent the internal bore, a first surface adjacent the first fluid chamber, and a second surface located adjacent the second fluid chamber, the side annular surface comprising a first annular surface located adjacent the first surface, a second annular surface located adjacent the second surface, and an annular groove that lies between the first annular surface and the second annular surface, the first annular surface having a maximum diameter that is less than the maximum diameter of the second annular surface, and a first sealing member positioned within the groove.

2. A hydraulic suspension system as in claim 1, wherein the first sealing member is a sealing ring and the annular groove extends completely around the first piston.

3. A hydraulic suspension system as in claim 1, wherein a diameter of the first annular surface gradually decreases from the annular groove to the first surface.

4. A hydraulic suspension system as in claim 1, wherein the annular groove comprises a side wall that generally faces the internal bore, a first wall that lies generally normal to the side wall, and a second wall that generally faces the first wall.

5. A hydraulic suspension system as in claim 4, wherein a second sealing member is positioned between the first sealing member and the side wall.

6. A hydraulic suspension system as in claim 5, wherein the second sealing member urges the first sealing member radially outward in a direction away from the side wall towards the internal bore.

7. A hydraulic suspension system as in claim 5, wherein the first sealing member is made of a first material and the second sealing material is made of a second material, the first material having a higher modulus of elasticity than the second material.

8. A hydraulic suspension system as in claim 7, wherein the first material is polytetrafluoroethylene.

9. A hydraulic suspension system as in claim 7, wherein the second material is rubber.

10. A hydraulic suspension system as in claim 1, wherein the second annular surface includes a second annular groove.

11. A hydraulic suspension system as in claim 10, wherein a second sealing member is positioned in the second annular groove.

12. A hydraulic suspension system as in claim 11, wherein the first sealing member is made of a first material and the second sealing member is made of a second material, the first material having a higher modulus of elasticity than the second material.

13. A hydraulic suspension system as in claim 13, wherein the first material is polytetrafluoroethylene.

14. A hydraulic suspension system as in claim 13, wherein the second material is rubber.

15. A hydraulic suspension system comprising a cylinder assembly having a smaller diameter portion with a first inner bore that defines small diameter internal space and larger diameter portion with a second inner bore that defines a large diameter internal space that is in communication with the small diameter internal space, a piston rod extends within the small and larger diameter internal spaces, a first piston coupled to the piston rod and disposed within the large diameter space to separate the large diameter space into a first fluid chamber and a second fluid chamber, a second piston also coupled to the piston rod and disposed with the small diameter internal space to separate the small diameter space into a third fluid chamber and a fourth fluid chamber, the third fluid chamber being in communication with the first fluid chamber, the first piston comprising a side annular surface located adjacent the internal bore, a first surface adjacent the first fluid chamber, and a second surface located adjacent the second fluid chamber, the side annular surface comprising a first annular surface located adjacent the first surface, a second annular surface located adjacent the second surface, and an annular groove that lies between the first annular surface and the second annular surface, the first annular surface having a maximum diameter that is less than the maximum diameter of the second annular surface, and a first sealing member positioned within the annular groove.

16. A hydraulic suspension system as in claim 15, wherein the first sealing member is a sealing ring and the annular groove extends completely around the first piston.

17. A hydraulic suspension system as in claim 15, wherein the second piston defines a control passage for restricting the flow of fluid between third fluid chamber and the fourth fluid chamber upon movement of the second piston relative to the small diameter portion.

18. A hydraulic suspension system as in claim 17, further comprising a first suspension assembly and a second suspension assembly, the first suspension assembly being in hydraulic communication with the third fluid chamber and the second suspension assembly being in hydraulic communication with the fourth fluid chamber.

19. A hydraulic suspension system as in claim 18, wherein the first suspension assembly is associated with a left wheel of a vehicle and the second suspension assembly is associated with a right wheel of the vehicle.

20. A hydraulic suspension system as in claim 18, wherein the first suspension assembly is associated with a front wheel of a vehicle and the second suspension assembly is associated with a rear wheel of the vehicle.

21. A hydraulic suspension system as in claim 15, wherein a diameter of the first annular surface gradually decreases from the annular groove to the first surface.

22. A hydraulic suspension system as in claim 15, wherein a biasing member is disposed within the second fluid chamber and is arranged to bias the first piston towards the small diameter portion.

23. A hydraulic suspension system as in claim 22, wherein the second fluid chamber contains a gas and the first, third and fourth fluid chambers contain a fluid.

24. A hydraulic suspension system as in claim 23, wherein the hydraulic suspension system is configured such that a maximum hydraulic pressure in the first fluid chamber is larger than a maximum hydraulic pressure in the second chamber.

25. A hydraulic suspension system as in claim 15, wherein the annular groove comprises a side wall that generally faces the internal bore, a first wall, and a second wall that generally faces the first wall.

26. A hydraulic suspension system as in claim 25, wherein a second sealing member is positioned between the first sealing member and the side wall.

27. A hydraulic suspension system as in claim 26, wherein the second sealing member urges the first sealing member radially outward in a direction away from the side wall towards the internal bore.

28. A hydraulic suspension system as in claim 26, wherein the first sealing member is made of a first material and the second sealing member is made of a second material, the first material having a higher modulus of elasticity than the second material.

29. A hydraulic suspension system as in claim 28, wherein the first material is polytetrafluoroethylene.

30. A hydraulic suspension system as in claim 28, wherein the second material is rubber.

31. A hydraulic suspension system as in claim 16, wherein the second annular surface includes a second annular groove.

32. A hydraulic suspension system as in claim 32, wherein a second sealing member is positioned in the second annular groove.

33. A hydraulic suspension system as in claim 33, wherein the first sealing member is made of a first material and the second sealing member is made of a second material, the first material having a higher modulus of elasticity than the second material.

34. A hydraulic suspension system as in claim 34, wherein the first material is polytetrafluoroethylene.

35. A hydraulic suspension system as in claim 34, wherein the second material is rubber.

36. A method for assembling a hydraulic cylinder of a hydraulic suspension system comprising, providing a piston with a side annular surface, a first surface, and a second surface, the side annular surface comprising a first annular surface located adjacent the first surface, a second annular surface located adjacent the second surface, and an annular groove that lies between the first annular surface and the second annular surface, the first annular surface having a maximum diameter that is less than the maximum diameter of the second annular surface, providing a cone shaped jig having a first end with a smaller diameter than a second end of the jig, providing an annular press, placing the second end of the jig adjacent the first surface of the piston, placing a sealing ring adjacent the first end of the jig, using the annular press to move a sealing ring over the jig and onto the annular surface of the piston and into the annular groove.

37. A method for assembling a hydraulic cylinder as in claim 36, further comprising inserting a second sealing ring into the annular groove before using the annular press to move the sealing ring over the jig and onto the annular surface of the piston.
